(19) United States
(12) Patent Application Publication
(10) Pub. No.: US 2011/0209639 A1
(43) Pub. Date: Sep. 1, 2011

(54) Rotary Press

(76) Inventor: Heinz-Jurgen Elbers, Horstel (DE)

(21) Appl. No.: 12/994,881

(22) PCT Filed: Apr. 16, 2009
(86) PCT No.: PCT/EP2009/002784

§ 371 Date: Feb. 24, 2011

(30) Foreign Application Priority Data
May 29, 2008 (DE) 10 2008 025 927.6

(51) Int. Cl. B41F 31/00

(52) U.S. Cl. 101/349.1

(57) ABSTRACT

According to the invention, a rotary printing machine with a printing cylinder and an ink delivery system for supplying the printing cylinder with ink with an ink chamber, which can be connected with an ink source, wherein the ink chamber has an ink discharge opening in the form of a slit, which extends mainly parallel to the printing cylinder axis and is aligned with the printing cylinder such that ink can be discharged into it.

The present invention relates to a rotary printing machine with a printing cylinder and an ink delivery system for supplying the printing cylinder with ink with an ink chamber, which is connectable with an ink source.

### BACKGROUND OF THE INVENTION

Rotary printing machines, in particular letterpress printing machines, mainly have a rotatably mounted printing cylinder, a correspondingly rotatably mounted impression cylinder, a printing screen, a doctor blade and a print material feed device. The print material to be printed is transferred to the rotating impression cylinder via the feed device. The impression cylinder rotates in the opposite direction in the rotational direction of the printing cylinder so that the print material is fed between both cylinders. During this movement, the ink located in the printing cylinder is applied to the print material. For this, a non-rotating doctor blade presses the screen meshes of the printing screen filled with ink, which at least in part forms the casing of the printing cylinder, onto the print material, which is located between the oppositely rotating cylinders. After the imprint, the print material is advanced further through the impression cylinder and is then transferred to a storage area.

A screen printing machine of the aforementioned type can process different types of paper depending on the requirement. In particular, both paper in continuous webs as well as individual pages can be printed. For individual webs, a grab retainer is provided in particular, which holds the paper during guidance along the impression cylinder. A corresponding doctor blade retainer and a linearly moveable doctor blade guide, which is drawn away from the grab retainer during printing, is described in DE 199 49 099 C2.

DE 102 32 254 B4 shows an ink delivery system arranged near the doctor blade, with an ink duct and a plurality of ink release openings, wherein the ink delivery system extends parallel to the doctor blade. On the basis of DE 199 49 099 C2, the printing ink is released via a control valve depending on a respective rotational position of the printing screen.

### PROBLEM STATEMENT

However, these known devices are unsuitable or at least impractical for applying an even inking to a printing screen of a rotary printing machine. Rather, according to the known method, considerably more ink than necessary is applied to the inside of the rotary printing screen, wherein the relatively high excess is cleared with the doctor blade.

The object of DE 102 32 254 B4 also addresses this problem statement in that an ink delivery system connected with the ink duct and extending parallel to the doctor blade with a plurality of ink dispending openings is arranged almost and in the rotational direction in front of the doctor blade. However, the printing ink is released in a controlled manner via at least one control valve depending on the respective rotational position of the printing screen, but only punctiform via a plurality of ink release openings.

### OBJECT

The object of the present invention is to provide an ink delivery system for rotary printing machines that take into consideration both the circumferential as well as the axial requirements of an even and economical ink supply.

### SOLUTION

This object is solved through a rotary printing machine with the characteristics of claim 1. Preferred embodiments of the invention are specified in the dependent claims.

### MAIN CLAIM

According to the invention, a rotary screen printing machine, in particular a rotary screen printing machine, with a printing cylinder and an ink delivery system with an ink chamber is provided. The ink delivery system serves to supply ink to the printing cylinder. The ink chamber can be connected with an ink source. The invention also provides that the ink chamber has an ink discharge opening in the form of a slit, which extends mainly parallel to the printing cylinder axis and is aligned with the printing cylinder such that the ink can be discharged into it.

### DEPENDENT CLAIMS

Ink, in particular ink for rotary printing machines, can have a plurality of processing properties. One of the important properties is the viscosity, the density and the particle size distribution of the ink pigments. Among other things, it can thus be wise to want to change the shape and size of the ink discharge opening. Thus, in an advantageous embodiment, the shape and size of the slit of the ink chamber can be changed by means of a cover plate. The cover plate can preferably be controlled and/or regulated by means of a quick tensioning means for example by means of a spindle. In particular, the cover plate can be moved into or respectively out of the ink discharge opening through the translatory movement of the spindle and thus reduce the cross-section of the ink discharge opening. Cover plates with a special design are also possible, for example with a sinusoidal or serrated contour over the length of the cover plate for a periodically changing ink distribution.

In order in particular to enable an even ink discharge over the length of the slit, the ink chamber can have flow guides. Suitable for this are for example webs or fins, which at least partially separate the ink flow in the ink chamber and/or guide or respectively steer the ink flow to areas of the ink chamber, which would be hardly or only slightly passed through without the flow guides.

In another advantageous embodiment, the ink chambers can be releasably fastened on an element of the remaining ink delivery system. For this, the ink delivery system can have at least one receptacle, which receive/s the ink chambers in the manner of an insert. A seal, in particular a silicone seal, can also be arranged between the receptacle and the insert. It is also possible that several ink chambers are also releasably fastened on one and/or if applicable several elements of the remaining ink delivery system. In another advantageous embodiment, at least one or more ink chambers can be fastened separately or in groups releasably on one and/or more elements of the remaining ink delivery system. A fastening can be designed such that the at least one ink chamber is fastened on an element of the remaining ink delivery system through quick tensioning means. In order to enable a correct or respectively a clear positioning of the releasable ink chamber, a guide, for example in the form of a tongue and groove, can be provided, which enables the exact positioning of the ink chamber relative to the remaining ink receptacle.

Furthermore, the rotary printing machine can have a pressure supply, from which the ink chambers, individually or together, are supplied. Thus, for example, each chamber can be supplied with pressure by one individual pressure supply or a pressure supply can supply several ink chambers mainly with the same pressure together by means of a supply chamber. For this, the pressure supply can also have a pump, in particular a spiral pump or a pump with a cylinder/piston arrangement. In an advantageous embodiment, the pressure supply is regulated depending on the pressures in the chambers. If the rotary printing machine has for example several same ink chambers, it can be enabled through the regulation of the pressure supply that the ink chambers are supplied with the same pressure. This is wise in particular when the boundary conditions of the ink chamber, in particular the settings of the cover plates, change over time. Thus, the regulation could for example guarantee a constant pressure demand in the chambers and/or in the pressure supply as such, even when the cover plates change the shape and/or size of the slit during the printing operation.

Moreover, it is possible that the rotary printing machine has different ink chambers, which preferably have the same pressure requirements, but in comparison to each other have different volume flow requirements. It is also possible here through a corresponding regulation to guide the pressure supply such that the pressures in the ink chambers meet the requirements, namely for example a constant pressure supply. Input parameters of a regulation of the aforementioned type can be signals of pressure, temperature and/or flow speed sensors. Output parameters of the regulation can be variables for operating devices, such as controllable valves, pressure reducers and/or the electrical voltage of motors, in particular for motors of the drive unit of the pressure supply.

The pressure supply can be controlled in another advantageous embodiment depending on the rotational position of the printing cylinder. Furthermore, a volume flow can be controlled and/or regulated from the slit depending on the rotational position of the printing cylinder preferably via at least one valve and/or cover plate. A possible input parameter of a control or a regulation can be for example the radial contour of a control disk connected with the printing cylinder and thus also rotating. The radial contour can be transferred to a controller and/or regulator through a non-rotating, radially moveable acceptor, preferably following the radial contour with rollers.

Besides the cover plate, which can change for example the shape and size of the slit, it is also possible that a volume flow to an ink chamber and thus also from the slit and/or the ink volume flow to several chambers can each be controlled or regulated by a valve.

According to the invention, a rotary printing machine, in particular a rotary screen printing machine, with a printing cylinder, its cylinder casing is made at least partially of a metallic printing screen.

### FIGURES

These and other characteristics and advantages of the present invention are described in greater detail with reference to the attached drawings of exemplary embodiments of the present invention.

FIG. 1 shows components of the rotary printing machine, in particular of the printing cylinder 1 and the ink supply 2 with an ink chamber 3. It is visible in particular from FIG. 1 that the ink delivery system 2 is arranged inside the printing cylinder. The ink chamber 3 has as shown an ink discharge opening 4 in the form of a slit 12, which extends mainly parallel to the printing cylinder axis and is aligned with the printing cylinder 1 such that ink can be discharged from the outlet opening 4 to the printing cylinder 1 in particular in front of a doctor blade 5. In an advantageous embodiment, the doctor blade 5 extends mainly parallel to the printing cylinder axis in rotational direction 6 of the printing cylinder behind the ink chamber. As shown in FIG. 1, the ink can thus be placed directly in front of the doctor blade 5 on the printing cylinder. In order to enable this proximity between the ink delivery system 2 and the doctor blade 5, the ink delivery system is fastened in particular by means of a screw connection 8 on a doctor blade holder 10 and thus also in contact with the doctor blade 5 itself. The ink delivery system 2 could also or alternatively be fastened on the doctor blade holder 10 by a rail guide so that a relative movement guided by means of a spindle along the rail level is possible with respect to the ink delivery system and the doctor blade holder. The rail guide could be arranged such that the ink delivery system 2 and in particular the ink discharge opening 4 are moved closer to the doctor blade 5 or further from the doctor blade 5 and/or the distance between the ink discharge opening 4 and the casing of the printing cylinder 1 is changed. Thus, for example, the ink discharge opening 4 can be arranged such a small distance above the printing cylinder 1 that a suction effect extends from the cylinder casing surface 26 over the ink up to into the ink discharge opening 4 of the ink delivery system 2 and in particular up to into the ink chamber 3.

FIG. 2 mainly shows the ink delivery system 2, which can extend for example over the entire width of a printing cylinder. For this, the ink delivery system 2 has several ink chambers 3 each with an ink discharge opening 4 in the form of a slit 12. As also shown in FIG. 2, the individual ink chambers 3 are aligned flush with each other. This means that they can lie in particular flush and parallel to the rotational axis of the printing cylinder 1 or form flush and lying the shape of a constant line in the cylinder casing surface. If the slits 12 of the several ink chambers 3, as also shown in FIG. 2, are arranged directly adjacent to each other, then these individual slits 4 can form a mainly continuous slit 14. In an advantageous embodiment, the cover plates can be coupled together, in particular through a mechanical connection or through a regulation, such that the shape and opening of the individual slits 12 and thus the continuous slit 14 is the same or respectively continuously steady and thus even. FIG. 2 also shows the contour 16 of the ink chambers 3, which extends from a supply line opening 18 to the slit 12.

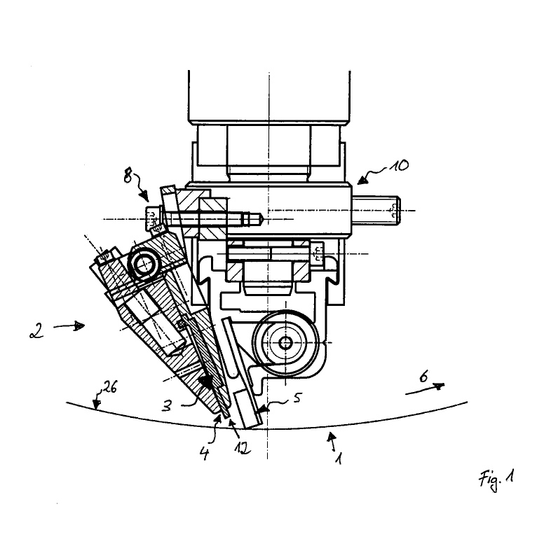

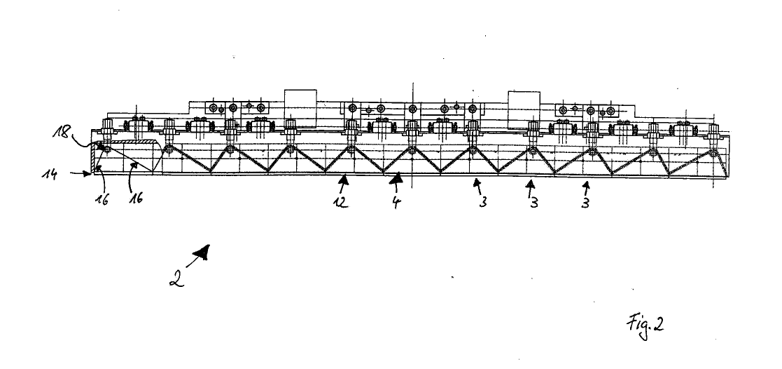

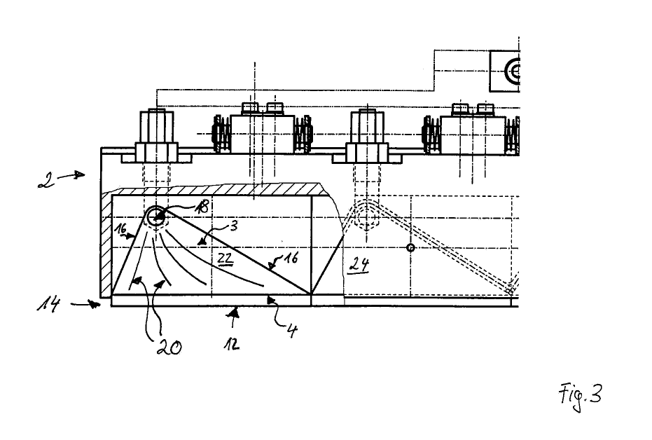

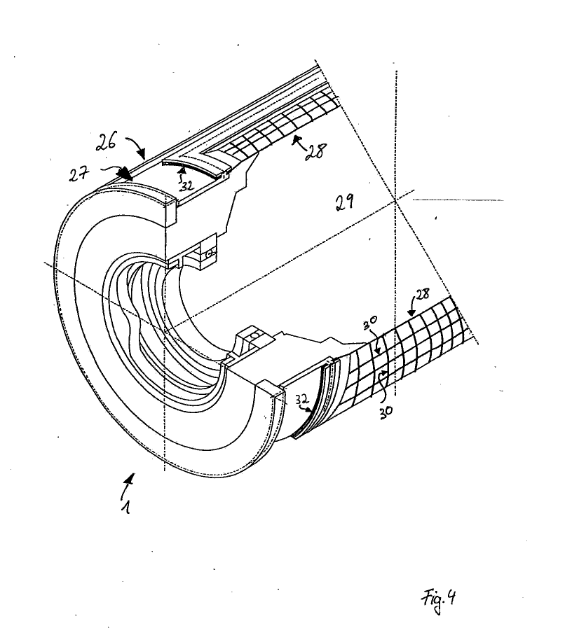

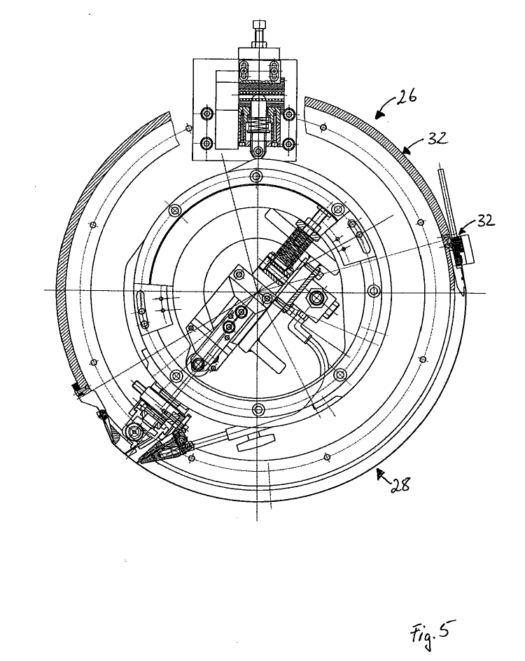

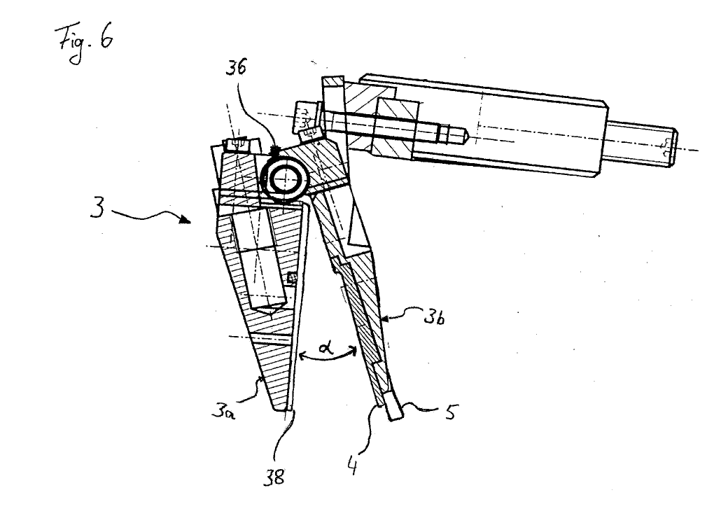

Flow guides 20, in particular webs and/or fins, are shown in FIG. 3. These guide at least partially the ink from the ink supply line opening 18 to the slit 12, in order to enable an even ink discharge over the length of the slit 12 or respectively over the length of the mainly continuous slit 14.

Furthermore, at least one side wall 22 of the ink chamber 3 is formed by an element of the remaining ink delivery system 2. It is also possible that both the rear side wall 22 and the front side wall 24, as also shown in FIG. 3, are formed by at least one element of the remaining ink delivery system 2. Besides the side walls 22 and 24, the ink chamber is formed by the contour 16 and the slit 12 as shown in FIG. 3. The contour 16 can preferably be formed analogous to the side walls 22 and 24 by at least one element of the remaining ink delivery system. Alternatively, the ink chamber can be designed as an insert. In such a potential embodiment, the insert is preferably formed by a side wall 24, an endwise circumferential edge with the contour 16 and a slit 12. The insert has in particular no side wall 22, as this is formed through the installation of the insert on the ink delivery system 2 by at least one element of the ink delivery system. The ink delivery system 2 can also have a receptacle, into which the insert can be inserted such that a defined positioning of the ink chamber 3 and/or the slit 12 is possible at the same time.

As also shown in FIG. 3, the ink supply opening 18 is arranged on a side wall 22 of the ink chamber. The arrangement of the ink supply opening 18 on another side wall in particular of the side wall 24 of the ink chamber 3 is also possible. Particularly advantageous is the arrangement of the ink supply opening 18 on one of the aforementioned side walls of the ink chamber, which is formed by at least one element of the remaining ink delivery system. Then thus can a releasably fastened ink chamber 3 be replaced or respectively fastened or released and separated without impacting the ink supply opening 18. In a particularly advantageous embodiment, the contour-shaped side wall 16 of the ink chamber insert can be pushed away over the ink supply opening 18 so that the ink supply opening 18 points in the direction of the ink chamber(s) 3. Potential contact surfaces between the walls of the ink chamber, in particular between its walls formed by at least one element of the ink delivery system 2 and their remaining walls are in particular sealed with silicone seals.

FIG. 4 shows for example the printing cylinder 1 of a rotary printing machine, in particular a rotary screen printing machine, in a perspective, cut representation. The cylinder casing 26 of the printing cylinder 1 is at least partially formed by a metallic printing screen 28. The casing surface 26 of the printing cylinder 1 has segment-wise, in particular in square form, recesses 29, which are bridged by the printing screen 28, so that in the case of a fastening of the printing screen 28 or the screen frame 32 with printing screen 28 on the casing surface 26 of the printing cylinder 1, its outer diameter is only slightly increased. In another advantageous embodiment, the printing cylinder 1 can have a depression 27 in particular a circumferential depression 27, which connects in particular to the segment-wise recess 29. The printing screen 28 or the screen frame 32 with printing screen 28 can be fastened on the printing cylinder 1 in the area of the depression 27 so that the outer radius over the circumference of the printing cylinder 1 is mainly the same and in particular does not increase in the area of the recess 29.

So that the printing screen 28 of the circumferential and axial contour of the cylinder casing surface 26 can take place in a bridging manner, it is advantageous that the printing screen 28 is braided out of metallic threads 30. The braiding of these threads 30 can take place for example crosswise in the axial and circumferential direction. Alternative and/or supplementary metal threads can for example also run diagonally or at any other angle and/or be arranged with respect to each other such that low frictional resistance results between doctor blade 5 and printing screen 28 during printing. In order to be able to resist the mechanical stress of the printing screen 28, in particular by the doctor blade 5, the printing screen is produced at least partially galvanically. In another advantageous embodiment, the printing screen 28 can be equipped with for example hexagonal holes as a type of perforated sheet.

In order to fasten in particular indirectly the printing screen 28 in a simple manner on the casing surface 26 of the printing cylinder 1, the printing screen 28 is fastened on a screen frame 32. The screen frame 32 can in turn be releasably fastened on the printing cylinder 26. In particular, the screen 28 and/or the screen frame 32 are mainly even before their fastening on the printing cylinder 26.

Furthermore, the printing screen frame 32 is preferably only bendable in the circumferential direction so that the screen frame 32 and the printing screen 28 connected with it can be adjusted to the rounding contour 34 as also shown in FIG. 5. For this, the screen frame 32 can be releasably fastened on the printing cylinder 1 in particular through a screw connection or other quick tensioning means such as clips, clamps or connectors. The printing screen 28 can deviate from the rounding contour of the printing cylinder 1 in as much as it has only a slightly larger radius than the printing screen 28. This deviation can result in that the mainly flat screen frame 32 is fastened on the printing cylinder 1 from the outside, in particular if it has no depression 27. However, in the case of an even thickness of the screen frame 32, the printing screen 28 then continues to have the same rotational axis as the cylinder casing 26 or respectively as the printing cylinder 1.

In contrast to conventional printing screens, which are made of plastic for example, the preferably metallic printing screen 28 according to the invention has a considerably higher stability, in particular inherent stability. The overall stability of the printing screen 28 is also increased in that the printing screen 28 is permanently connected with the screen frame 32. Printing screens that can be fastened by means of a resistance welding process or adhesion to the screen frame 32 are particularly well suited for this. This has the particular advantage that a power transmission from the printing screen 28 to the screen frame 32, for example in the case of a load by the doctor blade 5, can take place via the mainly entire contact surface of the frame. Furthermore, the printing screen 28 is fastened on the printing cylinder 26 and/or on the screen frame 32 in a mainly stressfree manner. The screen frame 32 or respectively the printing cylinder 26 thus predetermine rather only the form of the printing screen. If the printing screen 28 is fastened on the screen frame 32, it is advantageous if the printing cylinder 26 and the screen frame 32 have position guides, for example in the manner of a tongue and groove so that the screen frame 32 is positioned as exactly as possible on the printing cylinder 26. A screw connection for positioning with the smallest possible tolerance measures is also possible. In order to generally avoid an undesired waviness of the screen, which can be brought about in particular by uneven preloading on the screen, the printing screen 28 is fastened on the printing cylinder 26 and/or on the screen frame 32 mainly without axial and/or tangential forces.

FIG. 6 shows an ink chamber 3 as located in the installed state inside the printing cylinder. By opening the two ink chamber halves 3a and 3b, a gap-like ink discharge opening 4 is released in the lower area of the ink chamber. On the sides, each ink chamber 3 is sealed with one or more seal elements 38. The bottom side or respectively edge of the ink chamber simultaneously forms the doctor blade 5, which is pushed in the installed state from inside onto the printing screen and ensures an even distribution of the ink onto the printing screen.

The mounting of the two ink chamber surfaces is realized through a joint 36. The use of free-moving needle or ball bearings is suggested for a preferred mounting. For one, such bearings can be purchased economically as individual parts and secondly this purchase eliminates the need for a separate production effort. Production- and manufacturing-related errors can hereby be avoided.

The opening of the ink chamber is normally controlled via the setting of the system pressure, i.e. the pressure with which the printing ink is pressurized within the ink chamber. The closing process is preferably realized in this case via at least one spring, which in the moment of unpressurized material delivery exerts a higher force and presses the two ink chamber halves against each other and thus closes them. The at least one spring is preferably designed such that the spring force is adjustable. Excess pressure is first necessary to set a preload force for the opening of the ink chamber. This causes the ink chamber to close immediately after the pressure in the material supply or respectively the ink chamber is reduced to a value below a closing pressure. The closing process already begins at the time of pressure reduction and can thus be performed comparatively quickly.

In an alternative embodiment of the ink chamber, electrically, pneumatically or hydraulically driven setting means are provided instead of the at least one spring, with which the opening and closing of the ink chamber, thus in particular the ink discharge opening, are systematically controllable. An opening and closing of the ink discharge opening is realized with a high level of accuracy in this manner.

The opening angle α of the ink chamber is decisive for the ink volume flow besides the system pressure at which the printing ink is pressurized. The opening angle determines how much ink is transferred onto the screen.

In order to exclude unfavorable printing results to the greatest extent possible, the opening angle α should be limited in the case of the constructive design of the ink chamber for the rotary screen printing. If only a discrete opening angle is possible during the opening of the ink chamber 3, the ink volume flow is still only determined by an adjustable variable, namely the system pressure in the ink chamber and/or the material storage container. It is thereby possible to change the ink volume flow without difficulty and to dose exactly the ink amount necessary for the printing process through the use of suitable, finely adjustable pressure regulating valves. In order to be able to realize a consumption-dependent, exact ink dosing, it is necessary to ensure a homogenous ink flow on the ink discharge side 4 from the ink chamber 3. To achieve this, a special design of the ink chamber 3 provides the two ink chamber inner surfaces with fins. For one, the dimensional stability of the ink chamber 3 is considerably increased through this constructive measure and, secondly, a guided and controllable ink outflow is ensured through the use of fins.

In the known technical solutions, the opening process of the ink chamber and thus the opening angle and inevitably the ink volume flow are determined via the material pressure in the storage container and/or the ink chamber. In a constructive further development of the ink chamber of a rotary screen printing machine designed according to the invention, only the ink volume flow is set via the system pressure in the ink chamber and/or in the storage container. Besides a mechanical restriction of the opening angle of the ink chamber, it is thus suggested to uncouple the opening and closing process from the ink volume flow technically with the help of electrically, pneumatically or hydraulically adjustable setting means. The opening and closing of the ink chamber is hereby designed such that the setting unit fulfills this task independently of the regulation of the ink volume flow.

1. Rotary printing machine with a printing cylinder and an ink delivery system for supplying the printing cylinder with ink with an ink chamber, which can be connected with an ink source, characterized in that the ink chamber has an ink discharge opening in the form of a slit, which extends mainly parallel to the printing cylinder axis and is aligned with the printing cylinder such that ink can be discharged into it.

2. Rotary printing machine according to the previous claim, characterized in that the rotary printing machine is a rotary screen printing machine.

3. Rotary printing machine according to one of the previous claims, characterized in that the ink delivery system is arranged inside the printing cylinder.

4. Rotary printing machine according to one of the previous claims, characterized in that a doctor blade extends mainly parallel to the printing cylinder axis in the rotational direction of the printing cylinder behind the ink chamber.

5. Rotary printing machine according to one of the previous claims, characterized by several ink chambers each with an ink discharge opening in the form of a slit.

6. Rotary printing machine according to one of the previous claims, characterized in that the slits in the several ink chambers are aligned flush with each other.

7. Rotary printing machine according to one of the previous claims, characterized in that the slits in the several ink chambers are directly adjacent to each other and thus form a mainly continuous slit.

8. Rotary printing machine according to one of the previous claims, characterized in that the ink chamber is mainly flat with a contour, which extends from an ink supply opening to the slit.

9. Rotary printing machine according to one of the previous claims, characterized in that the shape and size of the slit in the ink chamber can be set by means of a cover plate, is controlled and/or regulated in particular by means of a quick setting means, preferably by means of a spindle.

10. Rotary printing machine according to one of the previous claims, characterized in that the ink delivery system is fastened, in particular releasably, on the doctor blade and/or on the doctor blade holder.

11. Rotary printing machine according to one of the previous claims, characterized in that the ink chamber has flow guides, in particular webs or fins, in order to enable and even ink discharge over the length of the slit.

12. Rotary printing machine according to one of the previous claims, characterized in that the ink chamber is fastened releasably to an element of the remaining ink delivery system.

13. Rotary printing machine according to the previous claim, characterized in that at least one of the several ink chambers is fastened separately or in groups releasably on one element of the remaining ink delivery system.

14. Rotary printing machine according to one of the two previous claims, characterized in that the at least one ink chamber is interchangeably fastened to an element of the remaining ink delivery system by quick tensioning means.

15. Rotary printing machine according to one of the previous claims, characterized in that at least one side wall of the ink chamber is formed by an element of the remaining ink delivery system.

16. Rotary printing machine according to one of the previous claims, characterized in that an ink supply opening is arranged on a side wall of the ink chamber, in particular on a side wall formed by at least one element of the remaining ink delivery system.

17. Rotary printing machine according to one of the previous claims, characterized by a pressure supply, from which the ink chambers are individually or, for example through a supply chamber, jointly supplied preferably mainly with the same pressure.

18. Rotary printing machine according to one of the previous claims, characterized in that the pressure supply has a pump, in particular a spiral pump or a pump with a cylinder/piston arrangement.

19. Rotary printing machine according to one of the previous claims, characterized in that the pressure supply is controlled depending on the rotational position of the printing cylinder.

20. Rotary printing machine according to one of the previous claims, characterized in that the pressure supply is regulated depending on the pressures in the ink chambers.

21. Rotary printing machine according to one of the previous claims, characterized in that an ink volume flow is controlled or regulated from the slit depending on the rotational position of the printing cylinder, preferably via at least one valve and/or the cover plate.

22. Rotary printing machine according to one of the previous claims, characterized in that the cylinder casing of the printing cylinder is formed at least partially from a metallic printing screen.

23. Rotary printing machine with a printing cylinder, characterized in that the cylinder casing of the printing cylinder is formed at least partially from a metallic printing screen.

24. Rotary printing machine according to one of the previous claims, characterized in that the printing screen is braided out of metallic threads.

25. Rotary printing machine according to one of the previous claims, characterized in that the printing screen is produced at least partially galvanically.

26. Rotary printing machine according to one of the previous claims, characterized in that the printing screen is fastened on a screen frame.

27. Rotary printing machine according to one of the previous claims, characterized in that the screen and/or the screen frame are mainly even before their fastening on the printing cylinder.

28. Rotary printing machine according to one of the previous claims, characterized in that the screen frame is bendable but otherwise dimensionally stable or has the same rounding contour as the printing cylinder.

29. Rotary printing machine according to one of the previous claims, characterized in that the screen frame is releasably fastened on the printing cylinder.

30. Rotary printing machine according to one of the previous claims, characterized in that the printing screen is fastened on the printing cylinder and/or on the screen frame mainly preload-free, in particular without axial and/or tangential force.
